(19) United States
(12) Patent Application Publication
(10) Pub. No.: US 2024/0182366 A1
(43) Pub. Date: Jun. 6, 2024

(54) FERRITE SINTERED BODY

(71) Applicant: Murata Manufacturing Co., Ltd., Kyoto (JP)

(72) Inventor: Kazuhide TSUNEMOTO, Nagaokakyo-shi (JP)

(73) Assignee: Murata Manufacturing Co., Ltd., Kyoto (JP)

(21) Appl. No.: 18/443,057

(22) Filed: Feb. 15, 2024

Related U.S. Application Data
(63) Continuation of application No. PCT/JP2022/028235, filed on Jul. 20, 2022.

(30) Foreign Application Priority Data
Aug. 17, 2021 (JP) 2021-132840

(51) Int. Cl. C04B 35/26; C04B 41/00

(52) U.S. Cl. CPC C04B 35/265; C04B 41/0072; C04B 2235/3274; C04B 2235/5436

(57) ABSTRACT

A ferrite sintered body comprising Co and Fe, wherein the Co is contained in an amount of from 38 mol % to 60 mol % in terms of CoO, the Fe is contained in an amount of from 40 mol % to 50 mol % in terms of Fe₂O₃, and the sintered body has an average particle size of from 1.0 μm to 5.0 μm.

### CROSS-REFERENCE TO RELATED APPLICATIONS

This application claims benefit of priority to International Patent Application No. PCT/JP2022/028235, filed Jul. 20, 2022, and to Japanese Patent Application No. 2021-132840, filed Aug. 17, 2021, the entire contents of each are incorporated herein by reference.

### BACKGROUND

### Technical Field

The present disclosure relates to a ferrite sintered body.

### Background Art

In recent years, the frequency of communication devices has been increased, and an inductance element suitable for use in a high frequency has been required. Conventionally, MnZn-based ferrite and NiZn-based ferrite have been used for high-frequency inductance elements, but the real part of the magnetic permeability starts to attenuate in the MHz band. In view of such a problem, JP-A-2004-123404 discloses Co-based ferrite as a ferrite in which the real part of the magnetic permeability hardly attenuates at MHz.

### SUMMARY

In the Co ferrite disclosed in JP-A-2004-123404, the real part of the magnetic permeability hardly attenuates in a high frequency band, but the imaginary part of the magnetic permeability rises from a frequency band lower than 1 GHz, for example, around 0.2 GHz. Therefore, the Co ferrite disclosed in JP-A-2004-123404 has a problem that magnetic loss is large in a high frequency band.

Accordingly, the present disclosure provides a ferrite sintered body that suppresses the attenuation of the real part of the magnetic permeability and the rise of the imaginary part of the magnetic permeability even in a high frequency band.

The present disclosure includes the following aspects.

[1] A ferrite sintered body comprising Co and Fe, wherein the Co is contained in an amount of 38 mol % or more and 60 mol % or less (i.e., from 38 mol % to 60 mol %) in terms of CoO, the Fe is contained in an amount of 40 mol % or more and 50 mol % or less (i.e., from 40 mol % to 50 mol %) in terms of Fe₂O₃, and the sintered body has an average particle size of 1.0 μm or more and 5.0 μm or less (i.e., from 1.0 μm to 5.0 μm).

[2] The ferrite sintered body according to [1], wherein the Co is contained in an amount of 41 mol % or more and 60 mol % or less (i.e., from 41 mol % to 60 mol %) in terms of CoO.

[3] The ferrite sintered body according to [1] or [2], further comprising Zn in an amount of more than 0 mol % and 9 mol % or less (i.e., from more than 0 mol % to 9 mol %) in terms of ZnO.

[4] The ferrite sintered body according to any one of [1] to [3], further comprising Ni in an amount of more than 0 mol % and 9 mol % or less (i.e., from more than 0 mol % to 9 mol %) in terms of NiO.

[5] The ferrite sintered body according to any one of [1] to [3], further comprising Cu and Ni in a total amount of more than 0 mol % and 9 mol % or less (i.e., from more than 0 mol % to 9 mol %) in terms of CuO and NiO, respectively.

[6] The ferrite sintered body according to any one of [1] to [5], wherein the sintered body has an average particle size of 1.4 μm or more and 4.0 μm or less (i.e., from 1.4 μm to 4.0 μm).

[7] A ferrite powder comprising Co and Fe, wherein the Co is contained in an amount of 38 mol % or more and 60 mol % or less (i.e., from 38 mol % to 60 mol %) in terms of CoO, the Fe is contained in an amount of 40 mol % or more and 50 mol % or less (i.e., from 40 mol % to 50 mol %) in terms of Fe₂O₃, and the powder has a BET specific surface area of 5.0 m2/g or more and 10 m2/g or less (i.e., from 5.0 m2/g to 10 m2/g).

[8] The ferrite powder according to [7], wherein the Co is contained in an amount of 41 mol % or more and 60 mol % or less (i.e., from 41 mol % to 60 mol %) in terms of CoO.

[9] The ferrite powder according to [7] or [8], further comprising Zn in an amount of more than 0 mol % and 9 mol % or less (i.e., from more than 0 mol % to 9 mol %) in terms of ZnO.

[10] The ferrite powder according to any one of [7] to [9], further comprising Ni in an amount of more than 0 mol % and 9 mol % or less (i.e., from more than 0 mol % to 9 mol %) in terms of NiO.

[11] The ferrite powder according to any one of [7] to [9], further comprising Cu and Ni in a total amount of more than 0 mol % and 9 mol % or less (i.e., from more than 0 mol % to 9 mol %) in terms of CuO and NiO, respectively.

[12] The ferrite powder according to any one of [7] to [11], wherein the BET specific surface area is 7.0 m2/g or more and 9.0 m2/g or less (i.e., from 7.0 m2/g to 9.0 m2/g).

[13] A method for producing a ferrite sintered body, the method comprising: obtaining an oxide mixture containing CoO in an amount of 38 mol % or more and 60 mol % or less (i.e., from 38 mol % to 60 mol %); Fe₂O₃ in an amount of 40 mol % or more and 50 mol % or less (i.e., from 40 mol % to 50 mol %); ZnO in an amount of 0 mol % or more and 9 mol % or less (i.e., from 0 mol % to 9 mol %); CuO in an amount of 0 mol % or more and 9 mol % or less (i.e., from 0 mol % to 9 mol %); and NiO in an amount of 0 mol % or more and 9 mol % or less (i.e., from 0 mol % to 9 mol %). The CuO and NiO are contained in a total amount of 0 mol % or more and 9 mol % or less (i.e., from 0 mol % to 9 mol %). The method also comprises pre-calcining the oxide mixture at a temperature of 600° C. or more and 700° C. or less (i.e., from 600° C. to 700° C.) to obtain a pre-calcined product; pulverizing the pre-calcined product so that the pre-calcined product has a BET specific surface area of 5.0 m²/g or more and 10 m²/g or less (i.e., from 5.0 m²/g to 10 m²/g) to obtain a pulverized product; molding the pulverized product to obtain a molded body; and calcining the molded body at a temperature of 1000° C. or more and 1150° C. or less (i.e., from 1000° C. to 1150° C.) to obtain a sintered body.

According to the present disclosure, it is possible to provide a ferrite sintered body that suppresses the attenuation of the real part of the magnetic permeability and the rise of the imaginary part of the magnetic permeability even in a high frequency band.

### DETAILED DESCRIPTION

Hereinafter, the ferrite sintered body of the present disclosure will be described.

The ferrite sintered body of the present disclosure contains at least Co and Fe.

The ferrite sintered body contains Co in an amount of 38 mol % or more, preferably 41 mol % or more, for example, 45 mol % or more, and 60 mol % or less, for example, 55 mol % or less, or 50 mol % or less, in terms of CoO and based on the total (in terms of oxide) of metal elements contained in the ferrite sintered body. In a preferred embodiment, Co may be contained in an amount of 38 mol % or more and 60 mol % or less (i.e., from 38 mol % to 60 mol %), and preferably 41 mol % or more and 60 mol % or less (i.e., from 41 mol % to 60 mol %), in terms of CoO and based on the total (in terms of oxide) of metal elements contained in the ferrite sintered body.

The ferrite sintered body contains Fe in an amount of 40 mol % or more, for example, 45 mol % or more, and 50 mol % or less, for example, 47 mol % or less in terms of Fe₂O₃ and based on the total (in terms of oxide) of metal elements contained in the ferrite sintered body. In a preferred embodiment, Fe may be contained in an amount of 40 mol % or more and 50 mol % or less (i.e., from 40 mol % to 50 mol %), for example, 40 mol % or more and 47 mol % or less (i.e., from 40 mol % to 47 mol %), in terms of Fe₂O₃ and based on the total (in terms of oxide) of metal elements contained in the ferrite sintered body.

The ferrite sintered body, containing Co and Fe in an amount of within the above range, can suppress the attenuation of the real part of the magnetic permeability and the rise of the imaginary part of the magnetic permeability in a high frequency band.

The ferrite sintered body of the present disclosure may further contain at least one selected from Zn, Ni, and Cu.

In one aspect, the ferrite sintered body of the present disclosure further contains Zn.

The ferrite sintered body contains Zn in an amount of more than 0 mol %, preferably 1 mol % or more, for example, 5 mol % or more, and 9 mol % or less, for example, 8 mol % or less, in terms of ZnO and based on the total (in terms of oxide) of metal elements contained in the ferrite sintered body. In a preferred embodiment, Zn may be contained in an amount of more than 0 mol % and 9 mol % or less (i.e., from more than 0 mol % to 9 mol %), and preferably 1 mol % or more and 9 mol % or less (i.e., from 1 mol % to 9 mol %), in terms of ZnO and based on the total (in terms of oxide) of metal elements contained in the ferrite sintered body.

The ferrite sintered body, containing Zn in an amount of within the above range, can increase the real part of the magnetic permeability in a high frequency band.

In one aspect, the ferrite sintered body of the present disclosure further contains Ni.

The ferrite sintered body contains Ni in an amount of more than 0 mol %, preferably 1 mol % or more, for example, 3 mol % or more, and 9 mol % or less, for example, 6 mol % or less, in terms of NiO and based on the total (in terms of oxide) of metal elements contained in the ferrite sintered body. In a preferred embodiment, Ni may be contained in an amount of more than 0 mol % and 9 mol % or less (i.e., from more than 0 mol % to 9 mol %), preferably 1 mol % or more and 9 mol % or less (i.e., from 1 mol % to 9 mol %), for example, 3 mol % or more and 6 mol % or less (i.e., from 3 mol % to 6 mol %), in terms of NiO and based on the total (in terms of oxide) of metal elements contained in the ferrite sintered body.

The ferrite sintered body, containing Ni in an amount of within the above range, can increase the coercive force and suppress the rise of the imaginary part of the magnetic permeability in a high frequency band.

In one aspect, the ferrite sintered body of the present disclosure further contains Cu.

The ferrite sintered body contains Cu in an amount of more than 0 mol %, preferably 1 mol % or more, for example, 3 mol % or more, and 9 mol % or less, for example, 6 mol % or less, in terms of CuO and based on the total (in terms of oxide) of metal elements contained in the ferrite sintered body. In a preferred embodiment, Cu may be contained in an amount of more than 0 mol % and 9 mol % or less (i.e., from more than 0 mol % to 9 mol %), preferably 1 mol % or more and 9 mol % or less (i.e., from 1 mol % to 9 mol %), for example, 3 mol % or more and 6 mol % or less (i.e., from 3 mol % to 6 mol %), in terms of CuO and based on the total (in terms of oxide) of metal elements contained in the ferrite sintered body.

The ferrite sintered body, containing Cu in an amount of within the above range, can suppress the rise of the imaginary part of the magnetic permeability in a high frequency band.

In one aspect, the ferrite sintered body of the present disclosure further contains Cu and Ni.

In this aspect, the ferrite sintered body contains Cu and Ni in a total amount of more than 0 mol %, preferably 1 mol % or more, for example, 3 mol % or more, and 9 mol % or less, for example, 6 mol % or less, in terms of CuO and NiO, respectively, and based on the total (in terms of oxide) of metal elements contained in the ferrite sintered body. In a preferred embodiment, Cu and Ni may be contained in a total amount of more than 0 mol % and 9 mol % or less (i.e., from more than 0 mol % to 9 mol %), preferably 1 mol % or more and 9 mol % or less (i.e., from 1 mol % to 9 mol %), for example, 3 mol % or more and 6 mol % or less (i.e., from 3 mol % to 6 mol %), in terms of CuO and NiO, respectively, based on the total (in terms of oxide) of metal elements contained in the ferrite sintered body.

The ferrite sintered body, containing Cu and Ni in an amount of within the above range, can suppress the rise of the imaginary part of the magnetic permeability in a high frequency band.

In a preferred aspect, the ferrite sintered body of the present disclosure is substantially free of metal elements other than the Fe, Co, Zn, Ni, and Cu. Here, the phrase “substantially free” means that metal elements are not contained in an amount exceeding the impurity level, and for example, metal elements may be contained in an amount unavoidable in production. For example, the phrase “substantially free of metal elements” means that the metal elements are contained in an amount of 0.01 mol % or less in terms of oxide.

In one aspect, the ferrite sintered body of the present disclosure contains substantially only Co and Fe as metal elements.

In another aspect, the ferrite sintered body of the present disclosure contains substantially only Co, Fe, and Zn as metal elements.

In another aspect, the ferrite sintered body of the present disclosure contains substantially only Co, Fe, and Ni as metal elements.

In another aspect, the ferrite sintered body of the present disclosure contains substantially only Co, Fe, Zn, and Ni as metal elements.

In another aspect, the ferrite sintered body of the present disclosure contains substantially only Co, Fe, Zn, Ni, and Cu as metal elements.

In another aspect, the ferrite sintered body may further contain an additive component. Examples of the additive component include, but are not limited to, Bi and Sn. The Bi may be contained (added) in an amount of 0.1 to 1 part by mass in terms of Bi₂O₃ based on 100 parts by mass of the total of Co (in terms of CoO), Fe (in terms of Fe₂O₃), Zn (in terms of ZnO), Cu (in terms of CuO), and Ni (in terms of NiO). The Sn may be contained (added) in an amount of 0.3 to 1.0 parts by mass in terms of SnO₂ based on 100 parts by mass of the total of Co (in terms of CoO), Fe (in terms of Fe₂O₃), Zn (in terms of ZnO), Cu (in terms of CuO), and Ni (in terms of NiO).

The sintered body has an average particle size of 1.0 μm or more, preferably 1.4 μm or more, for example, 1.9 μm or more, and 5.0 μm or less, preferably 4.0 μm or less, for example, 3.2 μm or less. In a preferred embodiment, the sintered body may have an average particle size of 1.0 μm or more and 5.0 μm or less (i.e., from 1.0 μm to 5.0 μm), and preferably 1.4 μm or more and 4.0 μm or less (i.e., from 1.4 μm to 4.0 μm).

The ferrite sintered body, having an average particle size of within the above range, can increase the coercive force and further increase the real part of the magnetic permeability and suppress the rise of the imaginary part in a high frequency band.

The average particle size of the ferrite sintered body is obtained by: obtaining an image through SEM observation of the polished surface of the mirror-polished sintered body; obtaining the equivalent circle size of 30 or more (for example, 30 or more and 50 or less (i.e., from 30 to 50)) particles from the image; and calculating the particle size at which the integrated value of the area is 50%.

In the magnetic permeability of the ferrite sintered body, preferably, the real part u′ is 1.3 or more and 2.7 or less (i.e., from 1.3 to 2.7) and the imaginary part u″ is 0.01 or more and 0.8 or less (i.e., from 0.01 to 0.8) at a frequency of 1 GHz or more and 5 GHz or less (i.e., from 1 GHz to GHz).

The ferrite sintered body of the present disclosure can be obtained by calcining the ferrite powder of the present disclosure.

The ferrite powder of the present disclosure contains Co and Fe.

The ferrite powder contains Co in an amount of 38 mol % or more, preferably 41 mol % or more, for example, 45 mol % or more, and 60 mol % or less, for example, 55 mol % or less, or 50 mol % or less, in terms of CoO and based on the total (in terms of oxide) of metal elements contained in the ferrite powder. In a preferred embodiment, Co may be contained in an amount of 38 mol % or more and 60 mol % or less (i.e., from 38 mol % to 60 mol %), and preferably 41 mol % or more and 60 mol % or less (i.e., from 41 mol % to 60 mol %), in terms of CoO and based on the total (in terms of oxide) of metal elements contained in the ferrite powder.

The ferrite powder contains Fe in an amount of 40 mol % or more, for example, 45 mol % or more, and 50 mol % or less, for example, 47 mol % or less in terms of Fe₂O₃ and based on the total (in terms of oxide) of metal elements contained in the ferrite powder. In a preferred embodiment, Fe may be contained in an amount of 40 mol % or more and 50 mol % or less (i.e., from 40 mol % to 50 mol %), for example, 40 mol % or more and 47 mol % or less (i.e., from 40 mol % to 47 mol %), in terms of Fe₂O₃ and based on the total (in terms of oxide) of metal elements contained in the ferrite powder.

The ferrite powder, containing Co and Fe in an amount of within the above range, can suppress the attenuation of the real part of the magnetic permeability and the rise of the imaginary part of the magnetic permeability, after calcination, in a high frequency band.

The ferrite powder of the present disclosure may further contain at least one selected from Zn, Ni, and Cu.

In one aspect, the ferrite powder of the present disclosure further contains Zn.

The ferrite powder contains Zn in an amount of more than 0 mol %, preferably 1 mol % or more, for example, 5 mol % or more, and 9 mol % or less, for example, 8 mol % or less, in terms of ZnO and based on the total (in terms of oxide) of metal elements contained in the ferrite powder. In a preferred embodiment, Zn may be contained in an amount of more than 0 mol % and 9 mol % or less (i.e., from more than 0 mol % to 9 mol %), and preferably 1 mol % or more and 9 mol % or less (i.e., from 1 mol % to 9 mol %), in terms of ZnO and based on the total (in terms of oxide) of metal elements contained in the ferrite powder.

The ferrite powder, containing Zn in an amount of within the above range, can increase the real part of the magnetic permeability, after calcination, in a high frequency band.

In one aspect, the ferrite powder of the present disclosure further contains Ni.

The ferrite powder contains Ni in an amount of more than 0 mol %, preferably 1 mol % or more, for example, 3 mol % or more, and 9 mol % or less, for example, 6 mol % or less, in terms of NiO and based on the total (in terms of oxide) of metal elements contained in the ferrite powder. In a preferred embodiment, Ni may be contained in an amount of more than 0 mol % and 9 mol % or less (i.e., from more than 0 mol % to 9 mol %), preferably 1 mol % or more and 9 mol % or less (i.e., from 1 mol % to 9 mol %), for example, 3 mol % or more and 6 mol % or less (i.e., from 3 mol % to 6 mol %), in terms of NiO and based on the total (in terms of oxide) of metal elements contained in the ferrite powder.

The ferrite powder, containing Ni in an amount of within the above range, has an increased BET specific surface area, and the obtained sintered body has a smaller average particle size. As a result, the sintered body has an increased coercive force and can suppress the rise of the imaginary part of the magnetic permeability in a high frequency band.

In one aspect, the ferrite powder of the present disclosure further contains Cu.

The ferrite powder contains Cu in an amount of more than 0 mol %, preferably 1 mol % or more, for example, 3 mol % or more, and 9 mol % or less, for example, 6 mol % or less, in terms of CuO and based on the total (in terms of oxide) of metal elements contained in the ferrite powder. In a preferred embodiment, Cu may be contained in an amount of more than 0 mol % and 9 mol % or less (i.e., from more than 0 mol % to 9 mol %), preferably 1 mol % or more and 9 mol % or less (i.e., from 1 mol % to 9 mol %), for example, 3 mol % or more and 6 mol % or less (i.e., from 3 mol % to 6 mol %), in terms of CuO and based on the total (in terms of oxide) of metal elements contained in the ferrite powder.

The ferrite powder, containing Cu in an amount of within the above range, can suppress the rise of the imaginary part of the magnetic permeability, after calcination, in a high frequency band.

In one aspect, the ferrite powder of the present disclosure further contains Cu and Ni.

In this aspect, the ferrite powder contains Cu and Ni in a total amount of more than 0 mol %, preferably 1 mol % or more, for example, 3 mol % or more, and 9 mol % or less, for example, 6 mol % or less, in terms of CuO and NiO, respectively, and based on the total (in terms of oxide) of metal elements contained in the ferrite powder. In a preferred embodiment, Cu and Ni may be contained in a total amount of more than 0 mol % and 9 mol % or less (i.e., from more than 0 mol % to 9 mol %), preferably 1 mol % or more and 9 mol % or less (i.e., from 1 mol % to 9 mol %), for example, 3 mol % or more and 6 mol % or less (i.e., from 3 mol % to 6 mol %), in terms of CuO and NiO, respectively, based on the total (in terms of oxide) of metal elements contained in the ferrite powder.

The ferrite powder, containing Cu and Ni in an amount of within the above range, can suppress the rise of the imaginary part of the magnetic permeability, after calcination, in a high frequency band.

In a preferred aspect, the ferrite powder of the present disclosure is substantially free of metal elements other than the Fe, Co, Zn, Ni, and Cu. Here, the phrase “substantially free” means that metal elements are not contained in an amount exceeding the impurity level, and for example, metal elements may be contained in an amount unavoidable in production. For example, the phrase “substantially free of metal elements” means that the metal elements are contained in an amount of 0.01 mol % or less in terms of oxide.

In one aspect, the ferrite powder of the present disclosure contains substantially only Co and Fe as metal elements.

In another aspect, the ferrite powder of the present disclosure contains substantially only Co, Fe, and Zn as metal elements.

In another aspect, the ferrite powder of the present disclosure contains substantially only Co, Fe, and Ni as metal elements.

In another aspect, the ferrite powder of the present disclosure contains substantially only Co, Fe, Zn, and Ni as metal elements.

In another aspect, the ferrite powder of the present disclosure contains substantially only Co, Fe, Zn, Ni, and Cu as metal elements.

In another aspect, the ferrite powder may further contain an additive component. Examples of the additive component include, but are not limited to, Bi and Sn. The Bi may be contained (added) in an amount of 0.1 to 1 part by mass in terms of Bi₂O₃ based on 100 parts by mass of the total of Co (in terms of CoO), Fe (in terms of Fe₂O₃), Zn (in terms of ZnO), Cu (in terms of CuO), and Ni (in terms of NiO). The Sn may be contained (added) in an amount of 0.3 to 1.0 parts by mass in terms of SnO₂ based on 100 parts by mass of the total of Co (in terms of CoO), Fe (in terms of Fe₂O₃), Zn (in terms of ZnO), Cu (in terms of CuO), and Ni (in terms of NiO).

The BET specific surface area of the powder is 5.0 m²/g or more, preferably 7.0 m²/g or more, for example, 8.0 m²/g or more, and 10 m²/g or less, preferably 9.0 m²/g or less, for example, 8.6 m²/g or less. In a preferred embodiment, the average particle size of the powder may be 5.0 m²/g or more and 10 m²/g or less (i.e., from 5.0 m²/g to 10 m²/g), and preferably 7.0 m²/g or more and 9.0 m²/g or less (i.e., from 7.0 m²/g to 9.0 m²/g).

The ferrite powder, having a BET specific surface area of within the above range, has a low calcining temperature, and after calcination, the sintered body has a small average particle size.

The BET specific surface area of the ferrite powder is obtained by: preparing a slurry of the ferrite powder; and measuring the BET specific surface area of the ferrite powder in the slurry with a specific surface area analyzer (for example, Macsorb (registered trademark) (manufactured by Mountech Co., Ltd.)).

The ferrite powder can be obtained by: mixing oxides of each metal element as raw materials; and pre-calcining the obtained mixture at a predetermined temperature.

Specifically, CoO in an amount of 38 mol % or more and 60 mol % or less (i.e., from 38 mol % to 60 mol %); Fe₂O₃ in an amount of 40 mol % or more and 50 mol % or less (i.e., from 40 mol % to 50 mol %); ZnO in an amount of 0 mol % or more and 9 mol % or less (i.e., from 0 mol % to 9 mol %); CuO in an amount of 0 mol % or more and 9 mol % or less (i.e., from 0 mol % to 9 mol %); and NiO in an amount of 0 mol % or more and 9 mol % or less (i.e., from 0 mol % or more and 9 mol %), and the CuO and NiO are contained in a total amount of 0 mol % or more and 9 mol % or less (i.e., from 0 mol % to 9 mol %), are mixed to obtain an oxide mixture. Next, the obtained oxide mixture is calcined at a temperature of 600° C. or more and 700° C. or less (i.e., from 600° C. or more and 700° C.), preferably 620° C. or more and 680° C. or less (i.e., from 620° C. to 680° C.). The obtained pre-calcined product is pulverized to obtain a ferrite powder having a BET specific surface area of 5.0 m²/g or more and 10 m²/g or less (i.e., from 5.0 m²/g to 10 m²/g).

The present disclosure also provides a method for producing a ferrite sintered body.

The method of producing a ferrite sintered body of the present disclosure includes obtaining an oxide mixture containing: CoO in an amount of 38 mol % or more and 60 mol % or less (i.e., from 38 mol % to 60 mol %); Fe₂O₃ in an amount of 40 mol % or more and 50 mol % or less (i.e., from 40 mol % to 50 mol %); ZnO in an amount of 0 mol % or more and 9 mol % or less (i.e., from 0 mol % to 9 mol %); CuO in an amount of 0 mol % or more and 9 mol % or less (i.e., from 0 mol % to 9 mol %); and NiO in an amount of 0 mol % or more and 9 mol % or less (i.e., from 0 mol % to 9 mol %). The CuO and NiO are contained in a total amount of 0 mol % or more and 9 mol % or less (i.e., from 0 mol % to 9 mol %). The method also includes pre-calcining the obtained oxide mixture at a temperature of 600° C. or more and 700° C. or less (i.e., from 600° C. to 700° C.) to obtain a pre-calcined product; pulverizing the obtained pre-calcined product so that the pre-calcined product has a BET specific surface area of 5.0 m²/g or more and 10 m²/g or less (i.e., from 5.0 m²/g to 10 m²/g) to obtain a pulverized product; molding the obtained pulverized product to obtain a molded body; and calcining the obtained molded body at a temperature of 1000° C. or more and 1150° C. or less (i.e., from 1000° C. to 1150° C.) to obtain a sintered body.

The sintered body of the present disclosure has a high coercive force and suppresses the attenuation of the real part of the magnetic permeability and the rise of the imaginary part of the magnetic permeability, being suitably used in an inductance element or the like.

Therefore, the present disclosure provides an inductance element including: an element body including a ferrite sintered body; and a coil embedded in the element body, wherein the ferrite sintered body is the ferrite sintered body according to the present disclosure.

Hereinafter, the present disclosure will be described with reference to Examples, but the present disclosure is not limited only to such Examples.

### Examples

CoO, Fe₂O₃, ZnO, CuO, and NiO were weighed so that the total amount of the oxides was 300 g at a predetermined ratio shown in Table 1, and 300 g of pure water, 6 g of an ammonium polycarboxylate dispersant, and 1.2 kg of 2 mmφ PSZ cobblestone were put in a 1000 cc pot made of a polyester material, and mixed with a ball mill at a rotation speed of 116 rpm for 16 hours. The obtained mixture was evaporated to dryness at a temperature of 120° C. to obtain a mixed dried powder. The mixed dried powder was passed through a sieve having a roughness of 425 μm to obtain a graded powder. The graded powder was pre-calcined in the air at 650° C. for 2 hours to obtain a pre-calcined powder. The crystal structure of the obtained pre-calcined powder was a spinel type single phase.

To 90 g of the obtained pre-calcined powder, 63 g of pure water, 1.8 g of an ammonium polycarboxylate dispersant, and 600 g of 5 mmφ PSZ cobblestone were put in a 500 cc pot made of a polyester material, and pulverized with a ball mill at a rotation speed of 154 rpm for 16 hours to obtain an atomized slurry. The Co-based ferrite powder contained in the obtained slurry was measured with a laser diffraction/scattering type particle size distribution measuring apparatus (manufactured by HORIBA, Ltd.) for the average particle size. The results are shown in Table 1. The Co-based ferrite powder contained in the slurry was measured with a specific surface area analyzer, Macsorb (registered trademark) (manufactured by Mountech Co., Ltd.) for the BET specific surface area. The results are shown in Table 1.

To the obtained atomized slurry, 10 g of an acrylic binder having a molecular weight of 20,000 and 0.5 g of dibutyl phthalate as a plasticizer were added. Then a sheet was formed through the doctor blade method (sheet material: polyethylene terephthalate, gap between blade and sheet: 200 μm, drying temperature: 60° C., and sheet winding speed: 20 cm/min). The obtained sheet was punched into a 4.5×2.5 cm square, and ferrite sheets obtained by peeling off and removing the polyethylene terephthalate sheet were stacked so that the total sheet thickness was 1.5 mm. The obtained laminate was placed in a stainless steel mold and pressure-bonded from above and below at a pressure of 200 MPa in a state of being heated at 60° C. to obtain a pressure-bonded body. For SEM observation, the pressure-bonded body was cut into a 2×1.5×5 mm block to obtain a processed body. For magnetic permeability measurement, the pressure-bonded body was cut into an 18×5×0.3 mm square plate after sintering to obtain a processed body. The processed body of each shape was placed on a zirconia setter, heated in the air at a temperature-raising rate of 0.5° C./min, a maximum temperature of 450° C., and a maximum temperature-holding time of 2 hours to thermally decompose and degrease the acrylic binder and the like, and then calcined at a temperature-raising/lowering rate of 5° C./min and a maximum temperature-holding time of 2 hours to obtain a sintered body of each shape.

The obtained block-shaped sintered body was embedded in a resin using an epoxy resin and a curing agent. The sintered body embedded in the resin was mirror-polished with an automatic polishing machine. The polished surface of the mirror-polished sintered body was observed with a SEM, and the equivalent circle size of 30 or more particles was obtained from the obtained image. Then the particle size at which the integrated value of the area was 50% was calculated as the average particle size. In addition, for the plate-shaped sintered body, the frequency characteristic of the magnetic permeability was measured with E5071C ENA vector network analyzer (Keysight Technologies), and the coercive force was measured with VSM-5 Vibrating Sample Magnetometer, which is manufactured by Toei Industry Co., Ltd. The results are shown in Table 2.

TABLE 1

| | | | | | | | | Characteristics of Co-based | | |
|---|---|---|---|---|---|---|---|---|---|---|
| | | | | | | Pre-calcining | | ferrite particle powder | | |
| Examples and | Composition | | | | | conditions | | Average | BET specific | |
| Comparative | Fe2O3 | CoO | ZnO | CuO | NiO | Temperature | Time | particle size | surface area | Crystal |
| Examples | [mol %] | [mol %] | [mol %] | [mol %] | [mol %] | [° C.] | [time] | [μm] | [m²/g] | structure |
| Example 1 | 40 | 60 | 0 | 0 | 0 | 650 | 2 | 1.23 | 7.63 | Spinel type |
| Example 2 | 50 | 50 | 0 | 0 | 0 | 650 | 2 | 1.29 | 8.04 | Spinel type |
| Example 3 | 40 | 55 | 5 | 0 | 0 | 650 | 2 | 1.87 | 8.06 | Spinel type |
| Example 4 | 50 | 45 | 5 | 0 | 0 | 650 | 2 | 2.31 | 8.01 | Spinel type |
| Example 5 | 40 | 54 | 0 | 3 | 3 | 650 | 2 | 1.35 | 7.77 | Spinel type |
| Example 6 | 40 | 51 | 0 | 3 | 6 | 650 | 2 | 1.26 | 8.00 | Spinel type |
| Example 7 | 40 | 51 | 0 | 6 | 3 | 650 | 2 | 1.36 | 7.63 | Spinel type |
| Example 8 | 50 | 44 | 0 | 3 | 3 | 650 | 2 | 1.40 | 8.39 | Spinel type |
| Example 9 | 50 | 41 | 0 | 3 | 6 | 650 | 2 | 1.36 | 8.52 | Spinel type |
| Example 10 | 50 | 41 | 0 | 6 | 3 | 650 | 2 | 1.29 | 8.09 | Spinel type |
| Example 11 | 47 | 42 | 5 | 3 | 3 | 650 | 2 | 2.12 | 8.02 | Spinel type |
| Example 12 | 47 | 38 | 9 | 3 | 3 | 650 | 2 | 1.93 | 7.92 | Spinel type |
| Example 13 | 40 | 54 | 0 | 0 | 6 | 650 | 2 | 1.34 | 7.97 | Spinel type |
| Example 14 | 40 | 51 | 0 | 0 | 9 | 650 | 2 | 1.42 | 8.16 | Spinel type |
| Example 15 | 50 | 44 | 0 | 0 | 6 | 650 | 2 | 1.34 | 8.38 | Spinel type |
| Example 16 | 50 | 41 | 0 | 0 | 9 | 650 | 2 | 1.42 | 8.45 | Spinel type |
| Example 17 | 47 | 43 | 5 | 0 | 5 | 650 | 2 | 2.13 | 7.77 | Spinel type |
| Example 18 | 47 | 39 | 9 | 0 | 5 | 650 | 2 | 1.97 | 7.75 | Spinel type |
| Comparative | 51 | 35 | 14 | 0 | 0 | 950 | 3 | 4.87 | 3.43 | Spinel type |
| Example 19 | | | | | | | | | | |
| Comparative | 48 | 24 | 28 | 0 | 0 | 1000 | 2 | 2.09 | 3.53 | Spinel type |
| Example 20 | | | | | | | | | | |
| Comparative | 47 | 23 | 25 | 0 | 5 | 950 | 2 | 2.20 | 4.43 | Spinel type |
| Example 21 | | | | | | | | | | |
| Comparative | 47 | 4 | 9 | 0 | 40 | 950 | 2 | 1.52 | 6.06 | Spinel type |
| Example 22 | | | | | | | | | | |
| Comparative | 47 | 4 | 9 | 20 | 20 | 950 | 2 | 4.10 | 2.85 | Spinel type |
| Example 23 | | | | | | | | | | |

TABLE 2

| | | | Characteristics of Co-based ferrite sintered body | | | | | | | | | Average |
|---|---|---|---|---|---|---|---|---|---|---|---|---|
| | Calcining | | | | | | μ″ | | | | | particle size |
| Examples and | conditions | | | | | | | | | | Coercive | of sintered |
| Comparative | Temperature | Time | μ′ | | | | | | | | force Hc | body |
| Examples | [° C.] | [time] | 0.5 GHz | 1 GHz | 3 GHz | 5 GHz | 0.5 GHz | 1 GHz | 3 GHz | 5 GHz | (A/m) | [μm] |
| Example 1 | 1050 | 2 | 1.33 | 1.33 | 1.32 | 1.35 | 0.00 | 0.01 | 0.01 | 0.02 | 5932 | 3.05 |
| Example 2 | 1150 | 2 | 1.39 | 1.39 | 1.37 | 1.32 | 0.02 | 0.03 | 0.09 | 0.14 | 10040 | 3.92 |
| Example 3 | 1000 | 2 | 1.71 | 1.70 | 1.72 | 1.85 | 0.02 | 0.02 | 0.05 | 0.13 | 4915 | 1.48 |
| Example 4 | 1125 | 2 | 2.02 | 2.03 | 1.72 | 1.53 | 0.07 | 0.13 | 0.45 | 0.34 | 7136 | 1.78 |
| Example 5 | 1050 | 2 | 1.32 | 1.32 | 1.32 | 1.34 | 0.00 | 0.01 | 0.01 | 0.02 | 4131 | 2.46 |
| Example 6 | 1050 | 2 | 1.30 | 1.30 | 1.30 | 1.33 | 0.01 | 0.01 | 0.01 | 0.02 | 4537 | 3.98 |
| Example 7 | 1050 | 2 | 1.31 | 1.31 | 1.30 | 1.34 | 0.01 | 0.01 | 0.01 | 0.02 | 5556 | 3.74 |
| Example 8 | 1100 | 2 | 1.44 | 1.44 | 1.41 | 1.33 | 0.02 | 0.04 | 0.13 | 0.18 | 10690 | 1.62 |
| Example 9 | 1100 | 2 | 1.47 | 1.47 | 1.43 | 1.31 | 0.02 | 0.04 | 0.16 | 0.21 | 10579 | 2.05 |
| Example 10 | 1050 | 2 | 1.49 | 1.49 | 1.45 | 1.32 | 0.03 | 0.05 | 0.18 | 0.23 | 12251 | 1.94 |
| Example 11 | 1000 | 2 | 1.79 | 1.79 | 1.85 | 1.86 | 0.02 | 0.02 | 0.10 | 0.40 | 7487 | 1.45 |
| Example 12 | 1000 | 2 | 2.38 | 2.39 | 2.63 | 2.20 | 0.04 | 0.05 | 0.47 | 0.77 | 4575 | 1.59 |
| Example 13 | 1100 | 2 | 1.30 | 1.30 | 1.29 | 1.32 | 0.01 | 0.01 | 0.01 | 0.02 | 5963 | 3.10 |
| Example 14 | 1050 | 2 | 1.30 | 1.30 | 1.30 | 1.32 | 0.01 | 0.01 | 0.01 | 0.02 | 6187 | 2.95 |
| Example 15 | 1100 | 2 | 1.36 | 1.36 | 1.36 | 1.35 | 0.01 | 0.02 | 0.07 | 0.15 | 11474 | 2.26 |
| Example 16 | 1100 | 2 | 1.38 | 1.37 | 1.38 | 1.35 | 0.02 | 0.03 | 0.08 | 0.16 | 12043 | 1.97 |
| Example 17 | 1050 | 2 | 1.76 | 1.76 | 1.81 | 1.84 | 0.02 | 0.03 | 0.10 | 0.40 | 6350 | 1.67 |
| Example 18 | 1050 | 2 | 2.25 | 2.27 | 2.47 | 2.02 | 0.04 | 0.05 | 0.46 | 0.71 | 4111 | 1.73 |
| Comparative | 1250 | 3 | 3.26 | 2.61 | 2.34 | 2.78 | 0.85 | 0.83 | 0.38 | 0.50 | 1567 | 5.86 |
| Example 19 | | | | | | | | | | | | |
| Comparative | 1270 | 2 | 7.89 | 3.14 | 0.52 | 0.23 | 13.02 | 7.95 | 2.99 | 1.63 | 2006 | 15.75 |
| Example 20 | | | | | | | | | | | | |
| Comparative | 1250 | 2 | 11.97 | 4.32 | 0.67 | 0.26 | 13.26 | 8.51 | 3.47 | 1.94 | 650 | 12.51 |
| Example 21 | | | | | | | | | | | | |
| Comparative | 1250 | 2 | 9.43 | 6.29 | 1.45 | 0.67 | 4.03 | 5.59 | 3.46 | 2.26 | 2006 | 5.73 |
| Example 22 | | | | | | | | | | | | |
| Comparative | 1050 | 3 | 6.80 | 3.92 | 1.81 | 0.75 | 4.14 | 3.80 | 3.57 | 2.07 | 2046 | 6.52 |
| Example 23 | | | | | | | | | | | | |

From the above results, it has been confirmed that the ferrite sintered body of the present disclosure has a high coercive force Hc of 4000 A/m or more, and attenuation of the real part μ′ of the magnetic permeability is suppressed and the imaginary part μ″ does not rise even at 1 GHz. On the other hand, it has been confirmed that the ferrite sintered body of each of Comparative Examples, which is outside the scope of the present disclosure, has a low coercive force, and further, the real part of the magnetic permeability decreases or the imaginary part rises at 1 GHz.

The ferrite material of the present disclosure may be used as a material for a high-frequency electronic component, in particular, inductance element.

What is claimed is:

1. A ferrite sintered body comprising Co and Fe, wherein
the Co is contained in an amount of from 38 mol % to 60 mol % in terms of CoO,
the Fe is contained in an amount of from 40 mol % to 50 mol % in terms of Fe₂O₃, and
the sintered body has an average particle size of from 1.0 μm to 5.0 μm.

2. The ferrite sintered body according to claim 1, wherein
the Co is contained in an amount of from 41 mol % to 60 mol % in terms of CoO.

3. The ferrite sintered body according to claim 1, further comprising:
Zn in an amount of from more than 0 mol % to 9 mol % in terms of ZnO.

4. The ferrite sintered body according to claim 1, further comprising:
Ni in an amount of from more than 0 mol % to 9 mol % in terms of NiO.

5. The ferrite sintered body according to claim 1, further comprising:
Cu and Ni in a total amount of from more than 0 mol % to 9 mol % in terms of CuO and NiO, respectively.

6. The ferrite sintered body according to claim 1, wherein
the sintered body has an average particle size of from 1.4 μm to 4.0 μm.

7. The ferrite sintered body according to claim 2, further comprising:
Zn in an amount of from more than 0 mol % to 9 mol % in terms of ZnO.

8. The ferrite sintered body according to claim 2, further comprising:
Ni in an amount of from more than 0 mol % to 9 mol % in terms of NiO.

9. The ferrite sintered body according to claim 2, further comprising:
Cu and Ni in a total amount of from more than 0 mol % to 9 mol % in terms of CuO and NiO, respectively.

10. The ferrite sintered body according to claim 2, wherein
the sintered body has an average particle size of from 1.4 μm to 4.0 μm.

11. A ferrite powder comprising Co and Fe, wherein
the Co is contained in an amount of from 38 mol % to 60 mol % in terms of CoO,
the Fe is contained in an amount of from 40 mol % to 50 mol % in terms of Fe₂O₃, and
the powder has a BET specific surface area of from 5.0 m²/g to 10 m²/g.

12. The ferrite powder according to claim 11, wherein
the Co is contained in an amount of from 41 mol % to 60 mol % in terms of CoO.

13. The ferrite powder according to claim 11, further comprising:
Zn in an amount of from more than 0 mol % to 9 mol % s in terms of ZnO.

14. The ferrite powder according to claim 11, further comprising:
Ni in an amount of from more than 0 mol % to 9 mol % in terms of NiO.

15. The ferrite powder according to claim 11, further comprising:
Cu and Ni in a total amount of from more than 0 mol % to 9 mol % in terms of CuO and NiO, respectively.

16. The ferrite powder according to claim 12, wherein
the BET specific surface area is from 7.0 m²/g to 9.0 m²/g.

17. The ferrite powder according to claim 12, further comprising:
Zn in an amount of from more than 0 mol % to 9 mol % s in terms of ZnO.

18. The ferrite powder according to claim 12, further comprising:
Ni in an amount of from more than 0 mol % to 9 mol % in terms of NiO.

19. The ferrite powder according to claim 12, further comprising:
Cu and Ni in a total amount of from more than 0 mol % to 9 mol % in terms of CuO and NiO, respectively.

20. A method for producing a ferrite sintered body, the method comprising:
obtaining an oxide mixture containing:
CoO in an amount of from 38 mol % to 60 mol %;
Fe₂O₃ in an amount of from 40 mol % to 50 mol %;
ZnO in an amount of from 0 mol % to 9 mol %;
CuO in an amount of from 0 mol % to 9 mol %; and
NiO in an amount of from 0 mol % to 9 mol %,
wherein the CuO and NiO are contained in a total amount of from 0 mol % to 9 mol %;
pre-calcining the oxide mixture at a temperature of from 600° C. to 700° C. to obtain a pre-calcined product;
pulverizing the pre-calcined product so that the pre-calcined product has a BET specific surface area of from 5.0 m²/g to 10 m²/g to obtain a pulverized product;
molding the pulverized product to obtain a molded body; and
calcining the molded body at a temperature of from 1000° C. to 1150° C. to obtain a sintered body.
